(19) United States
(12) Patent Application Publication
(10) Pub. No.: US 2026/0093273 A1
(43) Pub. Date: Apr. 2, 2026

(54) SMART LOGISTICS VEHICLE CONTROL SYSTEM AND METHOD THEREOF

(71) Applicants: Hyundai Motor Company, Seoul (KR); Kia Corporation, Seoul (KR)

(72) Inventors: Joon Ki Lee, Suwon, Gyeonggi-do (KR); Kyung Dong Park, Hwaseong, Gyeonggi-do (KR); Ji Hwan Jung, Seoul (KR); Suk Jae Youn, Yongin, Gyeonggi-do (KR); Seung Hyeon Kim, Goyang, Gyeonggi-do (KR)

(21) Appl. No.: 19/108,949

(22) PCT Filed: Dec. 20, 2022
(86) PCT No.: PCT/KR2022/020787

§ 371 Date: Mar. 5, 2025

(30) Foreign Application Priority Data
Oct. 19, 2022 (KR) 10-2022-0135006

(51) Int. Cl. G05D 1/698; G05D 107/70

(52) U.S. Cl. CPC G05D 1/6985; G05D 2107/70

(57) ABSTRACT

A smart logistics vehicle control system and method are configured to optimize data traffic through controlling a cluster of smart logistics vehicles. The smart logistics vehicle control system includes a robot selection part which selects, among a plurality of smart logistics vehicles, a master robot in charge of a center of a communication network for each communication section and a plurality of slave robots which are positioned within the communication section taken charge of by the master robot, and which are controlled by the master robot to transmit position data, and a robot control part for controlling to receive from the master robot the position data of the master robot and the slave robots collected by the master robot when the master robot and slave robot are selected by the robot selection part and to transmit the received position data to a server.

### TECHNICAL FIELD

The present disclosure relates to a smart logistics vehicle control system and method for optimizing data traffic through controlling a cluster of smart logistics vehicles.

### BACKGROUND ART

Smart logistics vehicles are being introduced for the flexible and efficient supply and transport of components and the like not only in general logistics warehouses and factories, but also in smart factories that manufacture products with different specifications by using various components.

Smart logistics vehicles are a concept that generally refers to an autonomous mobile robot (AMR), an automated guided vehicle (AGV), an unmanned forklift, and the like, and such a smart logistics vehicle can perform movement and work under the control of a regulation system.

The existing mobile robots (AMR, AGV) have been independently manufactured and provided with mobile robot control systems (ACS, AGV Control Systems) of each manufacturing company. However, users can handle various mobile robots depending on purposes, and a problem arises that individual ACS should be separately purchased for controlling when the number of mobile robots controllable by the ACS is exceeded or mobile robots are of different models.

In addition, Simultaneous Localization and Mapping (SLAM) algorithms for autonomous driving are generated for each ACS, and as a result, traffic congestion is induced as mobile robots cannot recognize the position of each other, thereby causing a problem of decreasing facility efficiency.

Therefore, in order to solve the problem described above, an integrated regulation system for regulating the ACSs may be provided to control each ACS. In this case, a server overload problem may rather occur because of a large amount of data processing as the integrated regulation system processes data of all mobile robots controlled by each ACS. Accordingly, inefficiency may also increase because of spending a large amount of expense on server for real-time processing of data.

The matters described as background technology above are only intended to enhance understanding of the background of the present disclosure, and should not be taken as an acknowledgment of corresponding to prior art already known to those skilled in the art.

### DISCLOSURE

### Technical Problem

The present disclosure is to provide a smart logistics vehicle control system and method, which can alleviate the load on a server received by an upper system by optimizing data traffic through controlling a cluster of smart logistics vehicles, reduce data delay according to traffic optimization, and reduce communication hardware costs of related systems.

The technical tasks to be achieved by the present disclosure are not limited to the technical tasks mentioned above, and other technical tasks not mentioned may be clearly understood by those skilled in the art to which the present disclosure belongs from the description below.

### Technical Solution

As a means for solving the technical task, the present disclosure includes a smart logistics vehicle control system composed of a robot selection part which selects, among a plurality of smart logistics vehicles, a master robot in charge of a center of a communication network for each communication section and a plurality of slave robots which are positioned within the communication section taken charge of by the master robot, and which are controlled by the master robot to transmit position data, and a robot control part for controlling to receive from the master robot the position data of the master robot and the slave robots collected by the master robot when the master robot and slave robot are selected by the robot selection part and to transmit the received position data to a server.

For example, the robot selection part may select one of the plurality of slave robots as a sub robot when the slave robot controlled by the master robot deviates from the communication section taken charge of by the master robot.

For example, the robot selection part may select the master robot and the sub robot, respectively by turning on and off a function of the master robot and a function of the sub robot, respectively.

For example, the robot selection part may be the smart logistics vehicle control system characterized by selecting as the sub robot the slave robot closest to the slave robot deviated from the communication section.

For example, the sub robot may collect the position data of the sub robot itself and the position data of the slave robot allocated to the sub robot itself and may transmit the same to the master robot.

For example, the robot selection part may select a robot, which minimizes data transmission/reception latency, as the master robot among the plurality of smart logistics vehicles.

For example, the master robot may remove duplicate position data from the collected position data of the master robot and the slave robot, and transmit the same to the robot control part.

For example, the robot control part may communicate with the master robot via Wi-Fi Direct.

For example, the robot control part may communicate with the master robot via Bluetooth communication when not able to communicate via Wi-Fi Direct.

As a method for solving the technical task, the present disclosure includes selecting by a robot selection part among a plurality of smart logistics vehicles a master robot in charge of a center of a communication network for each communication section and a plurality of slave robots which are positioned within the communication section taken charge of by the master robot, and which are controlled by the master robot to transmit position data, receiving by a robot control part from the master robot the position data of the master robot and the slave robots collected by the master robot when the master robot and the slave robot are selected, and transmitting the received position data to a server by the robot control part.

For example, the selecting robots may select one of the plurality of slave robots as a sub robot when the slave robot controlled by the master robot deviates from the communication section taken charge of by the master robot.

For example, the selecting robots may select as the sub robot the slave robot closest to the slave robot deviated from the communication section.

For example, the selecting robots may select as the master robot a robot, which minimizes data transmission/reception latency, among the plurality of smart logistics vehicles.

For example, the receiving the position data from the master robot may enable the robot control part to receive the position data from the master robot by communicating with the master robot via Wi-Fi Direct.

For example, the receiving the position data from the master robot may communicate with the master robot via Bluetooth communication when not able to communicate via Wi-Fi Direct.

### Advantageous Effects

By the various exemplary embodiments of the present disclosure as described above, it is possible to alleviate the load on a server received by an upper system by optimizing data traffic through controlling a cluster of smart logistics vehicles, to reduce data delay according to traffic optimization, and to reduce communication hardware costs of related systems.

The effects obtained by the present disclosure are not limited to the effects mentioned above, and other effects not mentioned can be clearly understood by those skilled in the art to which the present disclosure belongs from the description below.

### DESCRIPTION OF DRAWINGS

FIG. 1 is a block diagram showing an example of a smart factory configuration applicable to exemplary embodiments of the present disclosure.

FIG. 2 is a block diagram showing an example of a regulation device configuration applicable to exemplary embodiments of the present disclosure.

FIG. 3 is a block diagram showing an example of a smart logistics vehicle configuration applicable to exemplary embodiments of the present disclosure.

FIG. 4 is a perspective view showing an example of an exterior of a smart logistics vehicle applicable to exemplary embodiments of the present disclosure.

FIG. 5 is a flowchart showing an example of a travelling process of a smart logistics vehicle applicable to exemplary embodiments of the present disclosure.

FIG. 6 is a block diagram showing a configuration of a smart logistics vehicle control system applicable to exemplary embodiments of the present disclosure.

FIG. 7 is a schematic diagram showing communication between a robot control part and a master robot, which is applicable to exemplary embodiments of the present disclosure.

FIG. 8 is a flowchart showing an example of a sub robot selection process of a robot selection part, which is applicable to exemplary embodiments of the present disclosure.

FIG. 9 is a flowchart showing an example of a response process when a communication abnormality situation occurs, which is applicable to exemplary embodiments of the present disclosure.

### BEST MODE

Hereinafter, exemplary embodiments disclosed in the present specification will be described in detail with reference to the accompanying drawings, but the same or similar components will be assigned with the same reference numbers regardless of the drawing symbols, and redundant descriptions thereof will be omitted. The suffixes “modules” and “parts” to components used in the following description may be assigned or used interchangeably only for the convenience of writing the specification, and may not be intended to have a distinct meaning or role in and of themselves. In addition, in describing the exemplary embodiments disclosed in the present specification, when it is determined that a detailed description of the related known technology may obscure the gist of the exemplary embodiments disclosed in the present specification, the detailed description thereof will be omitted. In addition, the accompanying drawings may be only intended to facilitate an easy understanding of the exemplary embodiments disclosed in the present specification, and the technical ideas disclosed in the present specification may not be limited by the accompanying drawings, and should be understood to include all modifications, equivalents, or substitutions that are within the spirit and technical scope of the present disclosure.

Terms including ordinal numbers, such as first, second, and the like, may be used to describe various components, but the components may not be limited by such terms. The terms may be used only for the purpose of distinguishing one component from another component.

When it is mentioned that a component is “connected” or “plugged into” another component, it should be understood that it is directly connected or plugged into that other component, but there may be other components in between. On the other hand, when it is mentioned that a component is “directly connected” or “directly plugged into” another component, it should be understood that there are no other components in between.

Singular expressions may include plural expressions unless the context clearly indicates otherwise.

In the present specification, it should be understood that terms such as “include” or “have” are intended to specify the presence of features, numbers, steps, operations, components, parts, or combinations thereof described in the specification, but do not exclude in advance the possibility of the presence or addition of one or more other features, numbers, steps, operations, components, parts or combinations thereof.

In addition, a unit or a control unit included in the internal configuration name of a smart logistics vehicle or a regulation device may be a term widely used to name a control device for controlling a specific function, but may not mean a generic function unit. For example, each control device may include a modem/transceiver for communicating with other control devices or sensors to control the function in charge, a memory for storing operating system or logic commands and input/output information, and one or more processors for performing judgments, calculations, decisions and the like necessary for control of the function in charge. Depending on implementations, a single processor may be in charge of calculations for a plurality of control devices.

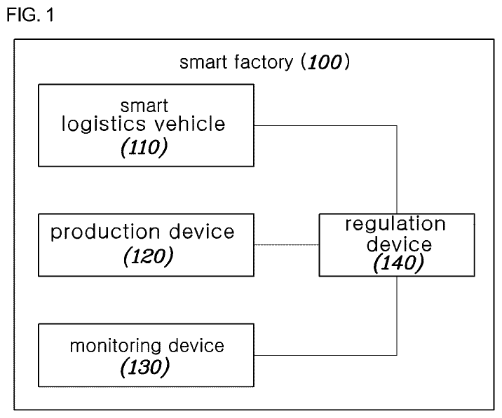

First, a configuration of a smart factory where a smart logistics vehicle is deployed and operated according to an exemplary embodiment will be described with reference to FIG. 1.

FIG. 1 is a block diagram showing an example of a smart factory configuration applicable to exemplary embodiments of the present disclosure.

Referring to FIG. 1, the smart factory 100 may include a smart logistics vehicle 110, a production device 120, a monitoring device 130, and a regulation device 140.

The smart factory 100 may be provided with a plurality of smart logistics vehicles 110, a plurality of production devices 120, and a plurality of monitoring devices 130 according to a production process and a target production speed of products. Hereinafter, each component will be described.

First, the smart logistics vehicle 110 may include an autonomous mobile robot (hereinafter, referred to as an “AMR” for convenience), an automated guided vehicle (hereinafter, referred to as an “AGV”) and an unmanned forklift. According to an operation policy of the smart logistics vehicle 110, only one of AGV and AMR may be operated in the smart factory 100, or the AGV and AMR may be operated together in a single smart factory 100.

The AGV may generally perform an operation (moving, turning, stopping, etc.) required within the smart factory 100 by recognizing and tracking a guide facility placed on the floor for the guide of the AGV. Herein, the guide facility may refer to an optically recognizable marker (spot, 2D code, etc.), a tag contactlessly recognizable at a short distance (e.g., NFC tag, RFID tag, etc.), a magnetic strip, wire, and the like, but this may be exemplary and is not necessarily limited thereto. The guide facility may be disposed continuously on the floor or may be discontinuously disposed to be spaced apart from each other. Since basically performing operations by recognizing and tracking the guide facility, the AGV may require the guide facility to be installed in advance before operation, so it may be necessary to physically establish or modify the guide facility when moving the AGV to a new path or modifying the existing path. In addition, when an obstacle is detected on or around the path, it may be common to stop until the detected obstacle is removed or until receiving a separate control since AGV does not deviate from the path established through the guide facility. Since controlling the AGV on the basis of the guide facility in the operation of the AGV, the regulation device 140 may transmit commands such as “travelling until the third marker is recognized” at the current position and “turning the heading direction by 90 degrees when the third marker is recognized” to the AGV in a unit of individual command or in a unit of mission (e.g., retrieve, supply, charge, patrol, etc.) including a plurality of commands.

The AMR may determine (i.e., positioning) the current position through sensing surroundings, and the point that its own path planning is possible by using the positioning and the map may be what is the most distinguished from the AGV. Therefore, when the AMR and the regulation device 140 share a coordinate-compatible map, the regulation device 140 may control the AMR in a manner of instructing the AMR a path on the basis of coordinates. In addition, when an obstacle is detected while travelling, the AMR may set its own avoidance path to avoid the obstacle and then return to the original path. A function of the regulation device 140 setting a path of AMR with one or more transit coordinates may be referred to as global path planning, and a function of the AMR setting a movement path or an avoidance path between transit coordinates based on the global path planning may be referred to as local path planning.

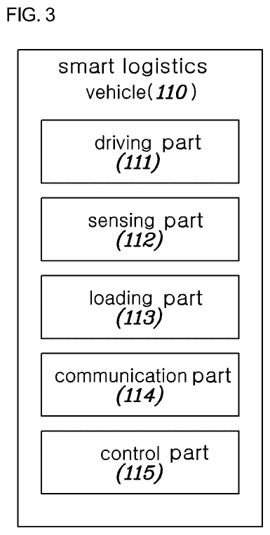

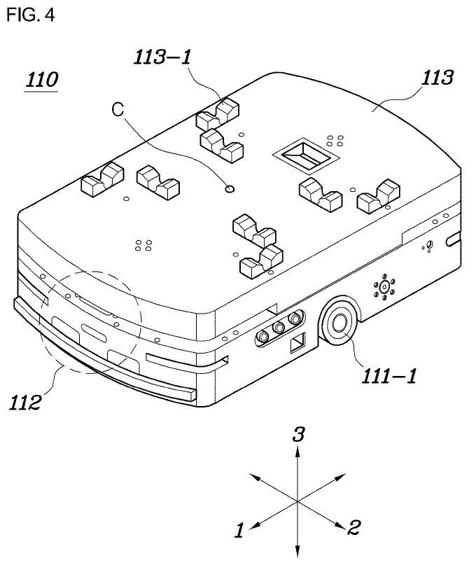

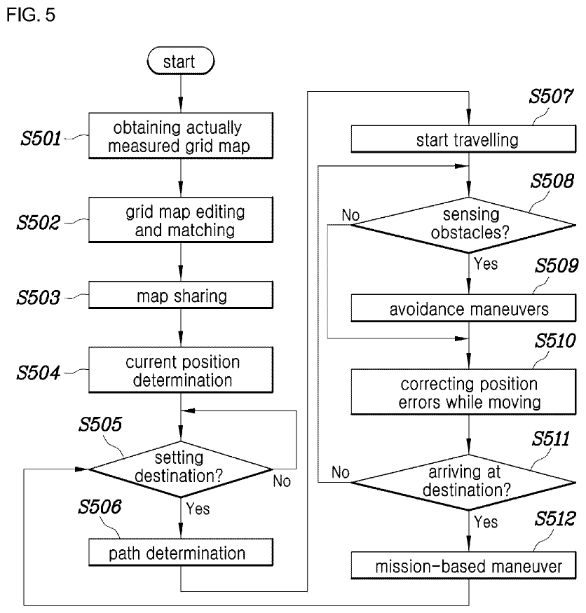

A more detailed configuration of the smart logistics vehicle 110 will be described later with reference to FIGS. 3 and 4, and a travelling control process of the AMR will be described later with reference to FIG. 5.

Next, the production device 120 may refer to a device (e.g., robot arm, conveyor belt, etc.) for performing a production process of a product in the smart factory 100, and in a broader sense, may refer to a device disposed to assist in performing a mission, such as entering or exiting of the smart logistics vehicle 110 when the production process is performed by a human. The device disposed to assist in performing a mission may be a device for sensing a state of a designated position where a pallet carried by the smart logistics vehicle 110 can be dropped off or collected, a device for determining the degree of process progress, and a means for blocking access to an area within the area where a specific production process is performed, but is not limited thereto.

For example, the production device 120 may be controlled through a programmable logic controller (PLC) and may communicate with the regulation device 140 in relation to the process progress.

The monitoring device 130 may perform a function of obtaining information for determining a situation in the smart factory 100 and transmitting the same to the regulation device 140. For example, the monitoring device 130 may include a camera, a proximity sensor, etc., but is not limited thereto.

The regulation device 140 may communicate with the components 110, 120, 130 described above and obtain information necessary to operate the smart factory 100 or control each component. For example, the regulation device 140 may perform the dispatching, path setting, mission allocation, process management for each product, material management, and the like of the smart logistics vehicle 110.

In implementations, the regulation device 140 may include a local regulation device (ACS: AMR/AGV Control System) that controls process facilities surrounding on the basis of the position of the AGV/AMR and performs mission-based control of the AGV/AMR, and an integrated regulation device (MoRIMS: Mobile Robot Integrated Monitoring System) that integrates and regulates two or more local regulation devices. The integrated regulation device may perform the state and path, logistics flow setting, and traffic control of all smart logistics robots 110 in the smart factory 100 from each of the plurality of local regulation devices. For example, when the local regulation device (ACS) is provided in a unit of smart logistics robot of the same manufacturer or the same model, the integrated regulation device may perform integrated control for collision prevention, such as analysis of bottleneck levels in intersection/overlapping areas, control of travelling acceleration/deceleration, and regeneration of avoidance paths, through traffic distribution control between heterogeneous models on the basis of information obtained through the plurality of local regulation devices (ACS).

Furthermore, the integrated regulation device may also have a Manufacturing Execution System (MES) as an upper control entity, and the Manufacturing Execution System (MES) may be again interlocked with an automation scheduler (APS: Advanced Planning & Scheduling).

In addition to the components 110, 120, 130, 140 of the smart factory 100 described above, a device for mutual communication between each component such as a beacon, a relay, an AP, and the like, a charger for charging the smart logistics vehicle 110, a loading space for storing or loading components, a space for storing a finished product or an intermediate product, a traffic light, a barrier, a waiting space of the idle smart logistics vehicle 110, and the like may be properly disposed in the smart factory 100.

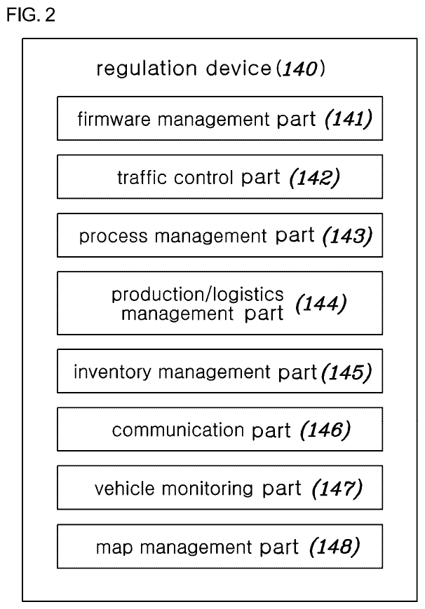

Hereinafter, a configuration of the regulation device 140 applicable to exemplary embodiments of the present disclosure will be described with reference to FIG. 2.

FIG. 2 is a block diagram showing an example of a regulation device configuration applicable to exemplary embodiments of the present disclosure. Each component shown in FIG. 2 mainly shows components related to exemplary embodiments of the present disclosure, and more or fewer components may be included in an actual implementation of the regulation device 140.

Referring to FIG. 2, the regulation device 140 may include a firmware management part 141, a traffic control part 142, a process management part 143, a production/logistics management part 144, an inventory management part 145, a communication part 146, a vehicle monitoring part 147, and a map management part 148.

The firmware management part 141 may obtain the latest firmware of the smart logistics vehicle 110 through the communication part 146 and transmit the same to the smart logistics vehicle 110, such that firmware update is performed to maintain the firmware of the smart logistics vehicle 110 in the latest state.

The traffic control part 142 may control traffic lights and barriers on the basis of the path of the smart logistics vehicle 110 and may recalculate the path of the smart logistics vehicle 110 according to traffic.

The process management part 143 may define a process for each product and may manage missions such as the degree of a process progress and a progress location, and the like.

The production/logistics management part 144 may dispatch the smart logistics vehicle 110 on a mission basis.

The inventory management part 145 may manage the position and quantity of each material, and this information may be useful for more efficient process operation, such as dispatching the smart logistics vehicle 110 for pallet pickup or retrieval to a destination in advance of the time when actual assembly/consumption of materials is detected.

The communication part 146 may communicate with not only internal components of the smart factory 100, such as a smart logistics vehicle 110, a production device 120, and a monitoring device 130, but also external entities, such as a firmware update server.

The vehicle monitoring part 147 may monitor the position, path, battery state, communication state, power train state, and the like of the individual smart logistics vehicle 110. Herein, the path may be a concept including a waypoint-based global path and a real-time local path. Also, the battery state may include a voltage, a current, a temperature, a peak value of a voltage and a current, a state of charge (SOC), a state of health (SOH), and the like. The communication state may include information on a currently activated communication protocol (Wi-Fi, etc.), a connected AP, a distance to the AP, a channel in use, and the like. Furthermore, the power train state may include a load, a temperature, an RPM, and the like of the driving system.

Besides, the vehicle monitoring part 147 may check the mission, the operation mode, the firmware version, and the like currently allocated to the individual smart logistics vehicle 110.

The map management part 148 may obtain map data in the form of a grid map obtained when an AMR among smart logistics vehicles 110 travels inside the smart factory 100, and may provide a tool for a factory manager to edit the obtained map data. Through the editing of the map data, zones, virtual lanes, intersections, prohibited areas, and the like where one or more preset operations are performed when the smart logistics vehicle 110 enters may be set, but this may be exemplary and is not necessarily limited thereto. In addition, the map management part 148 may distribute the corresponding map through the communication part 146 to the remaining smart logistics vehicles 110 other than the smart logistics vehicle 110 which obtains the initial grid map through actual travelling.

Next, a smart logistics vehicle will be described with reference to FIGS. 3 and 4.

FIG. 3 is a block diagram showing an example of a smart logistics vehicle configuration applicable to exemplary embodiments of the present disclosure.

Referring to FIG. 3, the smart logistics vehicle 110 may include a traveling part 111, a sensing part 112, a loading part 113, a communication part 114, and a control part 115. Hereinafter, each component will be described.

The travelling part 111 may include a driving source, a wheel, a suspension, and the like, which are involved in moving, steering, and stopping the smart logistics vehicle 110. The driving source may be an electric motor which receives power from an embedded battery (not shown). The wheels may include one or more driving wheels that receive a driving force from the driving source, and non-driving wheels that rotate by the movement of a vehicle body without receiving the driving force. Depending on an implementation, when a plurality of driving wheels are provided, the driving source may be matched to each driving wheel so that the rotation of each driving wheel may be independently controlled. In this case, by making the rotation directions of the driving wheels different from each other different, the steering may be achieved by rotating the vehicle body without a separate steering means. At least some of the non-driving wheels may be configured as caster type wheels, but this is exemplary and is not limited thereto.

The sensing part 112 may be for sensing an environment around the smart logistics vehicle 100 or a state of its own operation, and may include at least one of a 2D laser scanner (e.g., LiDAR), a 3D vision (stereo) camera, a multi-axis gyro sensor, an acceleration sensor, a wheel encoder, and a proximity sensor.

The encoder may output information for determining how much the wheel has rotated by using light emitted from a light emitting element (e.g. a photodiode). For example, the encoder may count the number of slits disposed along the circumferential direction on the wheel or the disk rotating together with the wheel in a unit of time. The control part 115 may perform odometry which estimates displacement by analyzing a position variation amount over time by using data obtained through the encoder and the gyro sensor. However, the displacement estimated on the basis of encoder data may have an error from actual displacement due to wheel slip or wear (variation in the dynamic radius of the wheel). Therefore, when performing odometry, the control part 115 may perform a correction for noise and error on the information collected from the wheel and gyro sensors by using a predetermined algorithm (e.g., EKF: Extended Kalman Filter) and then may output a result that tends to be close to an actual value. Such odometry may be particularly useful when current position determination (localization) using a 2D laser scanner, which will be described later, is not possible.

The 2D laser scanner may radiate a laser beam to the surroundings through a rotating reflector and may scan the surrounding environment by sensing a reflected and returned signal. In this case, a sensing result in the form of a point cloud may be output by analyzing the intensity of the reflected signal and the time difference between the irradiation and the reception.

The 3D vision camera may calculate a distance to the object on the basis of a parallax between two cameras spaced apart as much as a certain distance, that is, on the basis of a pixel distance between images captured by each camera. In this case, a texture projector that projects infrared light of a predetermined pattern may be provided in order to sense even a flat object (e.g., a white wall) of the same color.

In general, 2D laser scanners may be used for mapping, navigation, object recognition, and the like, and 3D cameras may be utilized for obstacle avoidance while navigating, but this is exemplary and is not necessarily limited thereto.

The loading part 113 may be a means for loading products to be transported, and may be in the form of the top plate itself of the vehicle body or a table disposed on the top plate, a lift, a turntable rotating along a vertical axis, a fork lift, a conveyor, or a combination thereof. A fork lift may support telescopic and tilting functions, similar to a forklift.

The communication part 114 may communicate with other components in the smart factory 100, such as the production device 120 and the regulation device 140, may support communication between the smart logistics vehicles 110, and may communicate with a charger when performing a charging mission.

The control part 115 may be an entity that performs overall control of each of the components 111, 112, 113, 114 described above and may perform a current mission, a current position, a destination determination, path planning, control of the loading part, and the like on the basis of information obtained from the regulation device 140 through the communication part 114.

FIG. 4 is a perspective view showing an example of an exterior of a smart logistics vehicle applicable to exemplary embodiments of the present disclosure.

Referring to FIG. 4, an example of AMR is illustrated as a smart logistics vehicle 110. The vehicle body may have a track-type planar shape having a long axis extending generally along a first axis direction. One driving wheel 111-1 may be disposed in the central portion of the vehicle body in the first axis direction, may be disposed at one side in the second axis direction, and another driving wheel (not shown) may be disposed at the other side in the second axis direction to face one driving wheel 111-1. Such an arrangement of driving wheels may be referred to as a differential drive (DD). Although not shown in FIG. 4, two or more non-driving wheels may be disposed at a lower portion of the vehicle body. In this case, when two driving wheels rotate at the same speed in the same direction, it may be possible to forward or backward along the first axis direction, and when rotating at the same speed in opposite directions, it may be possible to rotate on the basis of a rotation axis that extends along a third axis direction and passes through the plane center (C) of the vehicle body. In addition, the sensor part 112 may be disposed at the front surface of the vehicle body, and the loading part 113 may be disposed at the upper surface thereof. The loading part 113 may be configured to be able to rise and fall along the third axis direction, and a rack, a tray, or the like may be fixed to the upper surface through a guide 113-1.

However, the AMR form of FIG. 4 described above is exemplary, and it may be obvious that the AGV has a form similar to this or the AMR have a form different from this.

Next, a travelling process of the smart logistics vehicle 110 will be described with reference to FIG. 5.

FIG. 5 is a flowchart showing an example of a travelling process of a smart logistics vehicle 110 applicable to exemplary embodiments of the present disclosure. In FIG. 5, for convenience, it may be assumed that the smart logistics vehicle 110 is an AMR capable of positioning and local path setting.

Referring to FIG. 5, first, the AMR may obtain a grid map actually measured through a LiDAR or the like while travelling inside the smart factory 100 (S501).

When the AMR transmits the obtained grid map to the regulation device 140, a grid map editing and matching process may be performed in the map management part 148 of the regulation device 140 (S502). Herein, the editing process may include a process of setting the aforementioned various zones to the aforementioned grid map, a process of assigning a cost to each grid, and the like. Herein, the cost assignment may be performed in such a way that the cost is higher assigned as the AMR is closer to an obstacle or an entry prohibition area in order to prevent from moving around the obstacle or into an area that should not be reached. This may be because the AMR selects as a path a set of cells having the lowest cost among the way points when setting the local path.

In addition, the map matching process may refer to a process of matching coordinates among a CAD map used in the design of the smart factory 100, an actually measured grid map (LiDAR map), and a topology map passing through the editing process.

Thereafter, the regulation device 140 may share the topology map with all AMRs in the factory through the communication part 146 (S503).

A subsequent step may be a process applied to an individual AMR.

The AMR may determine the current position on the map (localization) through sensor data of the sensing part 112 and the obtained map (S504). For example, the AMR may determine the current position by comparing the surrounding terrain obtained through the LiDAR with the map on the basis of a feature point.

The regulation device 140 may select a specific AMR to assign a mission, and at least one way point generally determined through global path planning may be assigned to the mission. The way point may be defined as a coordinate on the map, and information on the direction (i.e., heading) in which the AMR should be directed at in the corresponding coordinate may be accompanied. According to such a mission assignment, a destination may be set in the AMR (Yes in S505), and the AMR may perform local path planning between way points on the basis of the cost of the topology map (S506).

When the path is determined, the AMR may start traveling (S507), and may perform an avoidance maneuver by performing a local path search for bypassing the detected obstacle (S509) when an obstacle is sensed through the sensing part 112 while traveling (Yes of S508). The regulation device 140 may update the mission of the corresponding AMR depending on cases, the avoidance maneuver or the failure of the avoidance maneuver.

In addition, the AMR may correct position errors through the aforementioned odometry technique while traveling until arriving at the destination (S510).

Then, when arriving at the destination (S511), the AMR may perform a mission-based maneuver (S512). For example, the AMR may determine whether a condition for entering a specific process area is cleared, retrieve an empty pallet from the destination, or drop a load on the loading part 113.

In an exemplary embodiment disclosure, proposed is a smart logistics vehicle control system capable of optimizing data traffic through the control of a cluster of smart logistics vehicles.

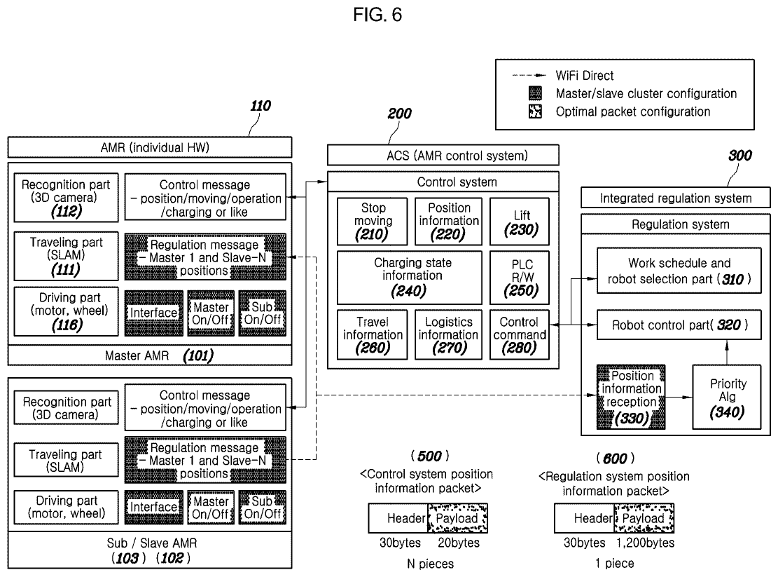

Hereinafter, a smart logistics vehicle control system according to an exemplary embodiment will be described with reference to FIG. 6.

FIG. 6 is a block diagram showing a configuration of a smart logistics vehicle control system applicable to exemplary embodiments of the present disclosure. FIG. 6 mainly shows components related to the present exemplary embodiment, and it may be obvious that fewer or more components may be included in the actual implementation of the smart logistics vehicle control system.

The smart logistics vehicle control system according to an exemplary embodiment may include a robot selection part 310 and a robot control part 320. The ACS 200 or the integrated regulation system 300 may include the robot selection part 310 and the robot control part 320. Referring to FIG. 6, a mobile robot 110 may include a master robot 101, a sub robot 103 to be described later, and a slave robot 102. The master robot 101, the sub robot 103 to be described later, and the slave robot 102 all may have the same hardware and may include a recognition part 112, a traveling part 111, and a driving part 116. In addition, a control message on the moving and stop information 210, position information 220, and charging state information 240 of the mobile robot 110 may be received from the ACS 200. The sending and receiving relationship of position data of the mobile robot 110 will be described later. Subsequently, the integrated regulation system 300 may receive the position data from the ACS 200 and may transmit a control command to the ACS 200 according to the logistics work schedule information 310. Since direct control of the mobile robot 110 in charge is essentially required, the ACS 200 may collect control information from each robot and position data from the master robot 101 in real time. For example, the ACS 200 may receive and control moving and stop information 210, position information 220, lift information 230, charging state information 240, control operation information (PLC R/W, 250), travel information 260, logistics information 270, and control command information 280. In the communication method between the mobile robots 110, individual robot for control may communicate on the basis of MQTT-based Wi-Fi 6 communication, and the transmission of position data of the master robot 101 may be communicated through Wi-Fi Direct to be described later.

In addition, the integrated regulation system 300 may collect only the position data transmitted from the master robot 101 to the ACS 200 as the priority of traffic arrangement of the entire mobile robot 110. The integrated regulation system 300 may perform traffic control 320 on the basis of a priority algorithm 340 of the position data 330 received through Wi-Fi Direct technology to be described later. Meanwhile, the control system position data packet 500 controlled by the ACS 200 and the regulation system position data packet 600 controlled by the integrated regulation system 300 may be composed of a header (30 bytes, assumption) and a payload (20 bytes, assumption). In this case, the instantaneous data reception amount based on 100 AMRs in the ACS 200 may be calculated as position data (50 bytes*100)+control data (50 bytes*100*9), which is 50000 bytes, and an overload may be caused as excessive data is received. However, when position traffic data is optimized and transmitted to the integrated regulation system 300, which is an upper system, according to an exemplary embodiment of the present disclosure, the instantaneous data reception amount based on 100 AMRs may be position data (30 bytes+1200 bytes) such that excessive data is not received and an overload is not caused.

Hereinafter, each component will be described.

The robot selection part 310 may select the master robot 101, the sub robot 103 to be described later, and the slave robot 102. First, the robot selection part 310 may select as the master robot 101 a robot that minimizes data transmission/reception latency. The master robot 101 may take charge of the center of communication network for each communication section, and may serve to receive position data from the lower sub robot 103 and a plurality of slave robots 102 and transmit the same to the ACS 200 as one data.

When a single mobile robot 110 receives information of the remaining dozens of robots, traffic may be overloaded, and the short-range communication (Wi-Fi Direct 150 m) that can be covered by the single master robot 101 may be limited in an operating factory size. Accordingly, the master robot 101 may be selected through the following process. The communication distance of Wi-Fi Direct may be usually 200 m, and the general manufacturing plant may often exceed this. Accordingly, the master robot 101 may be selected by creating a GRID with 80% (20% for safety) of the communication distance and utilizing the corresponding grid as a base cluster. One day before production after selection, data cluster analysis in space/time through simulation may be performed to calculate a cluster where the Euclidean distance is the smallest and the minimum number of master robots 101 is operated. The network structure theory may have a structure of a node (mobile robot 110) and a link (connection line). In order to select the master robot 101 that minimizes data transmission/reception latency (minimum sum of Euclidean distances between robots) among the mobile robots 110 in the computational cluster, the mobile robot 110 having the highest closed centrality should be selected as the master robot 101 by utilizing the network structure. In addition, the position data as a representative may be transmitted to the mobile robot 110 control system (ACS 200) and the mobile robot integrated monitoring system through Wi-Fi Direct to be described later. However, for real-time control, each mobile robot 110 should maintain real-time communication with the ACS 200 through Wi-Fi 6.

Meanwhile, the ACS 200 transmission data (including position data) may be transmitted 1:1 for each AMR, but the position data may proceed as one data of the master robot 101. The robot selection part 310 may select a cluster for each major cell of the layout on the basis of a cluster control algorithm, and may select as the master robot 101 an entity having the strongest node centrality there. In addition, a plurality of slave robots 102 may be selected, located within the communication section taken charge of by the master robot 101, and controlled by the master robot 101, thereby transmitting position data.

Thereafter, the master robot 101 may remove duplicate position data among the collected position data of the master robot 101 and position data of the slave robot 102 and may transmit the same to the robot control part 320, thereby preventing unnecessary traffic generation.

When the slave robot 102 controlled by the master robot 101 deviates from the communication section taken charge of by the master robot 101, the robot selection part 310 may select one of a plurality of slave robots 102 as the sub robot 103. The sub robot 103 may transmit to the master robot 101 the position data of the sub robot 103 itself together with the position data of the slave robot 102 which is allocated to the sub robot 103 itself and is located outside the control range of the master robot 101. Through this, this may ensure that no mobile robot 110 misses a position data transmission. The robot selection part 310 may select as the sub robot 103 a robot closest in Euclidean distance to the slave robot 102 located outside the control range of the master. However, when the sub robot 103 also deviates from the communication section taken charge of by the master robot 101, a robot closest in Euclidean distance to the sub robot 103 may be selected as the sub robot 103. In this case, a master robot 101—sub robot 103—sub robot 103—slave robot 102 structure can be formed.

Meanwhile, the selection of the master robot 101 and the sub robot 103 of the robot selection part 310 may be easily accomplished by turning on and off the function of the master robot 101 and the function of the sub robot 103, respectively. Meanwhile, whether to become the master robot 101 or the slave robot 102 may be determined in the clustering algorithm proceeding together with the simulation result of the previous day. Just as the master robot 101 and the slave robot 102 are updated every day, when the sub robot 103 is selected once, the position data of the slave robot 102 and its own position data may be transmitted to the master robot 101 on the selected day and the cluster algorithm may allocate again as the master robot 101 or the sub robot 103 on the next day.

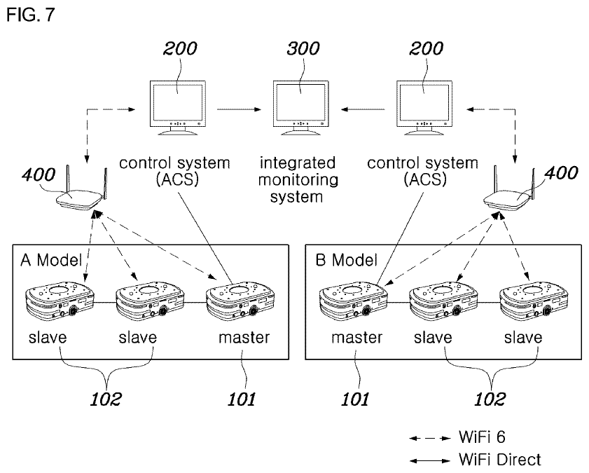

Subsequently, FIG. 7 is a schematic diagram showing communication between a robot control part 320 and a master robot 101, which is applicable to exemplary embodiments of the present disclosure.

Referring to FIG. 7, the robot control part 320 may communicate with the master robot 101 through a Wi-Fi Direct. The robot control part 320 may refer to the ACS 200, and the server may refer to the integrated regulation system 300. The robot control part 320 may receive from the master robot 101 the position data of the master robot 101 and the slave robot 102 collected by the master robot 101 and may transmit the received position data to the server. The mobile robot 110 may communicate with the control system (ACS 200) via Wi-Fi 6 in the MQTT (Message Queueing Telemetry Transport) manner, but the corresponding communication may require direct control. Accordingly, the robot control part 320 and the master robot 101 may require real-time communication with each other, so a near-field communication (NFC) technology such as Bluetooth or a beacon may be required. Bluetooth communication among various near-field communication (NFC) technologies may have a communication radius of 0.5 m to 100 m, a data transmission speed of about 24 Mb/s, and low power consumption. Communication between the robot control part 320 and the master robot 101 may use a method of communicating through Wi-Fi Direct among near-field communication (NFC) technologies, and Wi-Fi Direct communication may have a communication radius of about 200 m and a data transmission rate of about 500 Mb/s, which is a very high transmission rate. Wi-Fi Direct communication technology may have the following advantages. First, the communication distance may be the longest compared to Bluetooth or beacon. Second, in the case of Wi-Fi Direct, communication may be performed on the basis of the module of the main body without communicating through an AP like Wi-Fi 6, so that it is possible to simultaneously communicate with Wi-Fi6 communication. Third, when a Wi-Fi module exists inside the conventional mobile robot 110 hardware, it may be possible to use without adding a separate hardware cost.

In the event of a communication abnormality situation where it is not possible to communicate with the master robot 101 via Wi-Fi Direct, the robot control part 320 may communicate through Bluetooth communication. The communication abnormality situation may be largely caused by two situations. Specifically, there may be a communication distance exceeding situation and a communication disconnection situation caused by robot's WI-FI 6 communication failure. In the case of the communication distance exceeding situation, a failure response may be possible through the sub robot 103, and the communication disconnection situation caused by the communication distance exceeding may be very unlikely to occur when considering the slow moving speed (about 1.3 m/s) of the mobile robot 110. In the case of the communication disconnection situation caused by robot's WI-FI 6 communication failure, a Wi-Fi re-search should be performed, which takes approximately 4 seconds or more to perform. In addition, when performing a search procedure, a Wi-Fi interruption phenomenon may occur, which may hinder Wi-Fi 6 communication. To solve this problem, the sub robot 103 may be allocated to the nearest slave robot 102, and the allocated sub robot 103 and the slave robot 102 may share Wi-Fi search information through Bluetooth communication, and may perform a Wi-Fi Direct connection through the corresponding channel number and MAC address.

Meanwhile, even when the position data is transmitted to the ACS 200 as a representative packet through the master robot 101, a data traffic optimization method for distinguishing the packets according to the purpose may be required. In the case of the ACS 200 requiring real-time control, the position data and control data (stop information, moving information, deceleration information, etc.) of all mobile robots 110 within the control of the control system should be shared in real time, and the integrated monitoring system, which is the upper system of the ACS 200, will be more efficient in terms of data traffic when only the position data is transmitted in a bundle without transmitting the control data. To this end, by duplexing the data, the control data may be sent or received to be transmitted through Wi-Fi 6 and the position data may be sent or received to be transmitted through Wi-Fi Direct. Herein, since the control data is for real-time control purposes, the type of data may be within 0.2 ms of the transmission cycle, and the topic content may include position information, departure/destination information, control command information (acceleration/deceleration, stop, operation, etc.), robot state information, etc. Since the position data is for the purpose of identifying the current position, the transmission cycle may be within 0.4 m/s, and the movement information may be set to a predicted path, so that a smoothing technique can be applied to the movement motion. In addition, when a Wi-Fi Direct disconnection occurs due to abnormal situations such as a maximum transmission distance or a weak transmission signal, a search procedure required time (4 seconds) may occur, and in order to solve this, a cross-execution to instead search for nearby devices may be performed by using Bluetooth. As described above, when communication with the master robot 101 is impossible due to exceeding the transmission distance, the shortest path mobile robot 110 in the Euclidean distance may be assigned as the sub robot 103 to transmit its own position data to the sub robot 103 so that no mobile robot 110 misses transmission.

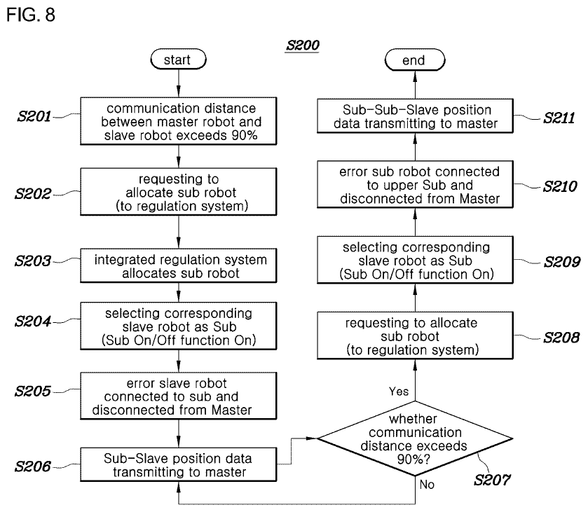

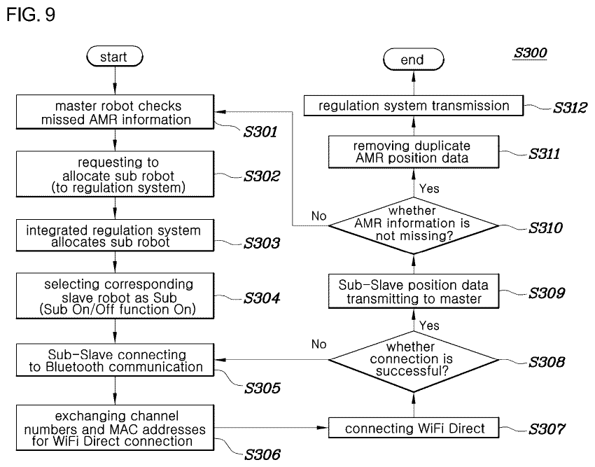

A smart logistics vehicle control method according to an exemplary embodiment based on the smart logistics vehicle control system described above will be described with reference to FIGS. 8 and 9.

FIG. 8 is a flowchart S200 showing an example of a sub robot 103 selection process of a robot selection part 310, which is applicable to exemplary embodiments of the present disclosure.

First, it may be assumed that the preset communication distance between the master robot 101 and the slave robot 102 is exceeded (S201). When the communication distance is exceeded, the master robot 101 may request the integrated regulation system 300 to allocate the sub robot 103 (S202). Thereafter, the integrated regulation system 300 may allocate the sub robot 103 (S203), and the slave robot 102 selected as the sub robot 103 may perform the functions of the sub robot 103 by turning on the functions of the sub robot 103, respectively (S204). In addition, the slave robot 102 exceeding the communication distance may be disconnected from the master robot 101, and the sub robot 103 may be connected to the master robot (101) for communication (S205). Thereafter, the sub robot 103 may transmit to the master robot 101 the position data of the sub robot 103 itself together with the position data of the slave robot 102 which is allocated to the sub robot 103 and is positioned outside the control range of the master robot 101 (S206). Even after allocation of the sub robot 103, it may be determined whether the predetermined communication distance between the master robot 101 and another slave robot 102 is exceeded (S207). When the communication distance is not exceeded (NO of S207), the sub robot 103 may continue to perform its own role. Conversely, when the communication distance is exceeded again (YES of S207), the master robot 101 for controlling the slave robot 102 which exceeds the communication distance may request the integrated regulation system 300 to allocate the sub robot 103 (S208). Likewise, as described above, the integrated regulation system 300 may allocate the sub robot 103 (S209). In addition, the slave robot 102 that exceeds the communication distance may be disconnected from the master robot 101, and the sub robot 103 may be communicatively connected to the master robot 101 (S210). Thereafter, the sub robot 103 may transmit to the master robot 101 the position data of the sub robot 103 itself together with the position data of the slave robot 102 which is allocated to the sub robot 103 and is positioned outside the control range of the master robot 101 (S211).

FIG. 9 is a flowchart S300 showing an example of a response process when a communication abnormality situation occurs, which is applicable to exemplary embodiments of the present disclosure.

First, when a communication abnormality situation occurs, the master robot 101 may check whether information of the mobile robot 110 controlled by itself is missing (S301). The master robot 101 may request the integrated regulation system 300 to allocate the sub robot 103 (S302). Thereafter, the integrated regulation system 300 may allocate the sub robot 103 (S303), and the slave robot 102 selected as the sub robot 103 may perform the functions of the sub robot 103 by turning on the functions of the sub robot 103, respectively (S304). The sub robot 103 and other slave robots 102 controlled by the master robot 101 may be connected to each other through Bluetooth communication (S305). The allocated sub robot 103 and the slave robot 102 may share Wi-Fi search information through Bluetooth communication and may perform Wi-Fi Direct connection through the corresponding channel numbers and MAC addresses (S306). Thereafter, the master robot 101 may attempt to establish a Wi-Fi Direct connection with the ACS 200 (S307), and when the Wi-Fi Direct connection is successful (YES in S308), the position data of the sub robot 103 and the slave robot 102 may be transmitted to the master robot 101 (S309). Thereafter, the master robot 101 may check whether information of the mobile robot 110, which is controlled by itself, is missing (S310). When it is determined that there is no missing information (YES of S310), the mobile robot 110 may remove duplicated position data among the collected position data of the master robot 101 and position data of the slave robot 102 and may transmit the same to the robot control part 320, thereby preventing unnecessary traffic generation (S311). Thereafter, the mobile robot 110 may transmit the collected position data (S312).

According to the smart logistics vehicle control system and method of the present disclosure, by optimizing data traffic through controlling a cluster of smart logistics vehicles, it is possible to alleviate the load on a server received by an upper system, to reduce data delay according to traffic optimization, and to reduce communication hardware costs of related systems.

Meanwhile, the present disclosure described above may be implemented as computer-readable code on a medium on which a program is recorded. The computer-readable medium may include all types of recording devices where data readable by a computer system is stored. Examples of computer-readable media may include hard disk drives (HDDs), solid state disks (SSDs), silicon disk drives (SDDs), ROMs, RAMS, CD-ROMs, magnetic tapes, floppy disks, optical data storage devices, and the like. Therefore, the detailed description described above should not be construed as restrictive in all respects and should be considered exemplary. The scope of the present disclosure should be determined by reasonable interpretation of the appended claims, and all changes within the equivalent scope of the present disclosure are included in the scope of the present disclosure.

Description of Reference Numerals

| | |
|---|---|
| 100: smart factory | 101: master robot |
| 102: slave robot | 103: sub robot |
| 110: smart logistics vehicle | 120: production device |
| 130: monitoring device | 140: regulation device |
| 200: ACS (AGV Control System) | 310: robot selection part |
| 320: robot control part | 300: integrated regulation |
| system | |

1. A smart logistics vehicle control system, the system comprising:
a robot selection part which selects, among a plurality of smart logistics vehicles, a master robot in charge of a center of a communication network for each communication section and a plurality of slave robots which are positioned within the communication section taken charge of by the master robot, and which are controlled by the master robot to transmit position data; and
a robot control part for controlling to receive from the master robot the position data of the master robot and the slave robots collected by the master robot when the master robot and slave robot are selected by the robot selection part and to transmit the received position data to a server.

2. The system of claim 1, wherein the robot selection part selects one of the plurality of slave robots as a sub robot when the slave robot controlled by the master robot deviates from the communication section taken charge of by the master robot.

3. The system of claim 2, wherein the robot selection part selects the master robot and the sub robot, respectively by turning on and off a function of the master robot and a function of the sub robot, respectively.

4. The system of claim 2, wherein the robot selection part selects as the sub robot the slave robot closest to the slave robot deviated from the communication section.

5. The system of claim 2, wherein the sub robot collects the position data of the sub robot itself and the position data of the slave robot allocated to the sub robot itself and transmits the same to the master robot.

6. The system of claim 1, wherein the robot selection part selects a robot, which minimizes data transmission and reception latency, as the master robot among the plurality of smart logistics vehicles.

7. The system of claim 1, wherein the master robot removes duplicate position data from the collected position data of the master robot and the slave robot, and transmits the same to the robot control part.

8. The system of claim 1, wherein the robot control part communicates with the master robot via Wi-Fi Direct.

9. The system of claim 8, wherein the robot control part communicates with the master robot via Bluetooth communication when the robot control part is not able to communicate via Wi-Fi Direct.

10. A smart logistics vehicle control method, the method comprising:
selecting by a robot selection part among a plurality of smart logistics vehicles a master robot in charge of a center of a communication network for each communication section and a plurality of slave robots which are positioned within the communication section taken charge of by the master robot, and which are controlled by the master robot to transmit position data;
receiving by a robot control part from the master robot the position data of the master robot and the slave robots collected by the master robot when the master robot and the slave robot are selected; and
transmitting the received position data to a server by the robot control part.

11. The method of claim 10, wherein the selecting robots selects one of the plurality of slave robots as a sub robot when the slave robot controlled by the master robot deviates from the communication section taken charge of by the master robot.

12. The method of claim 11, wherein the selecting robots selects as the sub robot the slave robot closest to the slave robot deviated from the communication section.

13. The method of claim 10, wherein the selecting robots selects as the master robot a robot, which minimizes data transmission and reception latency, among the plurality of smart logistics vehicles.

14. The method of claim 10, wherein the receiving the position data from the master robot enables the robot control part to receive the position data from the master robot by communicating with the master robot via Wi-Fi Direct.

15. The method of claim 14, wherein the receiving the position data from the master robot communicates with the master robot via Bluetooth communication when the robot control part is not able to communicate via Wi-Fi Direct.
